(19) United States
(12) Patent Application Publication
(10) Pub. No.: US 2025/0083071 A1
(43) Pub. Date: Mar. 13, 2025

(54) Gun Barrel, Separator, and Above Ground Storage Tank Recirculation and Nozzle Assembly

(71) Applicant: Enviroklean, Inc., Midland, TX (US)

(72) Inventors: John Hayden Williams, Frisco, TX (US); Armando C. Banister, Lovington, NM (US); Scott James Gilley, Aubrey, TX (US); Leif Erik Hardwick, Saint Hedwig, TX (US); Daniel Douglas Baker, Cleburne, TX (US); Adhikeshavan Ravee, Dallas, TX (US)

(21) Appl. No.: 18/463,651

(22) Filed: Sep. 8, 2023

(51) Int. Cl. B01D 17/02

(52) U.S. Cl. CPC B01D 17/0214

(57) ABSTRACT

A tank recirculation assembly comprising a recirculation line that draws fluid from the lower portion of a tank; and a pump that directs the recirculated fluid vertically toward and into the upper portion of the tank. The assembly comprises piping, pumping process and/or nozzles that spray the recirculated fluid across the surface oil inside of the tank. Recirculation is incorporated to enhance the recovery of more and cleaner oil by spraying as much of the surface area of the oil recovery zone to keep it clean. The then dispersed fluid travels down through the pad and reacts to help disperse and remove the interface that conglomerates in between the oil and water interface.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

This invention relates to oil and gas separation, namely, gun barrel/separator, and AST (Above Ground Storage Tank) tanks. Gun barrel, separator, and AST tanks are equipment used for the primary separation of crude oil and water. These tanks are typically large, horizontal vessels that allow for the settling of heavier solids and the separation of water from crude oil. The primary function of a gun barrel, separator, and/or AST tank is to facilitate the gravity separation process. When crude oil is extracted from the ground, it often contains water, sediments, and other impurities. The tank provides a controlled environment where these components can separate based on their density differences. This invention improves separation efficiency downtime between operations.

### 2. Description of the Related Art

Gun barrels, separators, and AST tanks have existed for roughly 150 years. They are generally characterized by the following features/attributes: inlet; retention time; settling; oil-water separation; oil outlet; and water outlet. Crude oil and water mixture enter the tank through an inlet. This inlet is designed to deliver the fluid to a fixed level within the tank and then diffuse the fluid and lower the velocities, while distributing the flow evenly across the tank, minimizing turbulence. The oil and water mixture is allowed to stay in the tank for a certain period, known as the retention time. During this time, gravity acts on the mixture, causing separation based on Stokes Law predicated on the density differences between the components. As the mixture enters the tank at the fixed internal level and is distributed across the diffuser plate, the heavier solid particles and sediments settle at the bottom of the tank due to their higher density. These settled solids are periodically removed from the tank through a sludge outlet. The lighter crude oil, oil wet solids and organics rise to the top of the tank, forming a layer known as the oil phase. Meanwhile, the water settles below the oil layer. To enhance the separation, certain tanks may have additional internals such as coalescing plates or corrugated plates that help to coalesce small droplets of oil, improving the efficiency of separation. The separated crude oil is typically withdrawn or floated over from the tank through an oil outlet located near the top of the tank. It is then further processed and treated to remove any remaining impurities. The separated water, which contains some residual oil, will typically pass though an internal or external water leg from the separation tank through a water outlet at the bottom post water leg. This water may undergo additional treatment processes to recover any remaining oil before being discharged or reused. Specific design features and operational parameters of gun barrel, separator and/or AST tanks may vary depending on the requirements of the oil and gas production facility, the characteristics of the crude oil being processed, and/or regulatory guidelines. Proper maintenance and periodic inspections are crucial to ensure efficient separation and prevent any operational issues. This is especially important in light of MIC (i.e., Microbiologically Influenced Corrosion), which results in lost storage capacity.

Despite the opportunity for variation, existing gun barrels are inefficient with respect to the recovery of produced crude oil. It is not uncommon to encounter hydraulic efficiency of 3% in typical gun barrels. The oil will become contaminated with iron sulfide (FeS), iron carbonate (FeCO₃), and calcium carbonate (CaCO₃). These oil-wet solids will pack off the separator's ability to float oil over by forming a crust that the oil cannot lift or penetrate over time, and during this packing out process the quality of the oil that is floating over will diminish in quality with higher levels of BS&W. Likewise, the oil-water interface will also grow and is referred to as the rag layer that consists of oil-wet solids, organics, and bacteria. These rag layers will dehydrate and harden under the oil layer, effectively trapping the oil between the crust and the rag layer. As the rag layers become more dense, the water quality of water leaving typical gun barrels is usually poor with amounts of oil carrying over into the water tanks. Additionally, gun barrels are subject to Non Production Time (NPT) caused by tank cleaning and maintenance that requires the tank to be taken offline, drained, with solids and sludge removed. As a result, operating time is reduced and there is a significant expense to haul off these solids and sludges to dispose of them. The present invention drastically improves these problems.

The present invention is superior to other known gun barrels because it: (1) improves hydraulic efficiency in enhanced oil recovery and water separation; (2) returns cleaner oil and water than other gun barrels; and (3) significantly reduces downtime due to cleaning and maintenance.

### BRIEF SUMMARY OF THE INVENTION

The invention is a system and method for enhanced oil-water separation. The present invention is designed to recirculate fluid from the bottom of a gun barrel, separator, and/or AST tank and return it to the top (or near the top) of the tank. The recirculated fluid returns via piping and/or one or more nozzles at the end of a recirculation line, which can be internal or external.

In addition to typical gun barrel components (e.g., tank, influent line, diffuser plate, oil flow over line, external water leg, gas port), an internal or external recirculation line is core to the present invention. Fluid is drawn from the bottom (or near bottom) of the tank into the recirculation line, pumped to the top (or near top) of the tank and returned to the interior of the tank. In some embodiments, the recirculation line has an outlet that flows recirculated fluid directly into the tank. In other embodiments, the recirculation line directs fluid into one or more nozzles, which return fluid into the interior of the tank at or above the oil float over line.

### BRIEF DESCRIPTION OF THE SEVERAL VIEWS OF THE DRAWINGS

For an improved understanding of the present invention, and the advantages thereof, reference is made to the following descriptions taken in conjunction with the accompanying figures:

FIG. 1 is a flow diagram showing a typical gun barrel assembly.

FIG. 2 is a flow diagram of one embodiment of the invention.

FIG. 3 is a flow diagram of an alternative embodiment of the invention.

FIG. 4 is a flow diagram of an alternative embodiment of the invention.

FIG. 5 is a flow diagram of an alternative embodiment of the invention.

FIG. 6 and FIG. 7 are two views of a vertical nozzle.

FIG. 8 is a vertical nozzle adjustable diffuser head.

FIG. 9 is a vertical nozzle adjustable diffuser base.

FIG. 10 and FIG. 11 are two views of a horizontal nozzle.

FIG. 12 is a flow diagram showing a gun barrel and multiple water tank assembly configured as a single train that has an over/under flow through system that has been disclosed in the prior art.

FIG. 13 is a flow diagram showing a gun barrel and multiple water tank assembly configured as a single train that has a bladder tank flow that has been disclosed in the prior art.

FIG. 14 is a flow diagram of one embodiment of the present invention wherein a gun barrel and multiple water tank assembly is configured as a single train that has a bladder tank flow.

FIG. is a flow diagram of one embodiment of the present invention wherein a gun barrel and multiple water tank assembly is configured as a single train that has an over/under flow-through system.

FIG. 16 is a flow diagram of one embodiment of the present invention wherein a multiple gun barrel and multiple water tank assembly is configured as two parallel multi-tank trains that have a bladder tank flow system.

FIG. 17 is a flow diagram of one embodiment of the present invention wherein a multiple gun barrel and multiple water tank assembly is configured as two parallel multi-tank trains that have an over/under flow-through system.

FIG. 18 is a flow diagram of one embodiment of the present invention showing two above-ground storage tanks with one gun barrel configured as a flow-through system that has been disclosed in the prior art.

FIG. 19 is a flow diagram of one embodiment of the present invention wherein two above-ground storage tanks with one gun barrel are configured as a flow-through system.

### DETAILED DESCRIPTION OF THE INVENTION

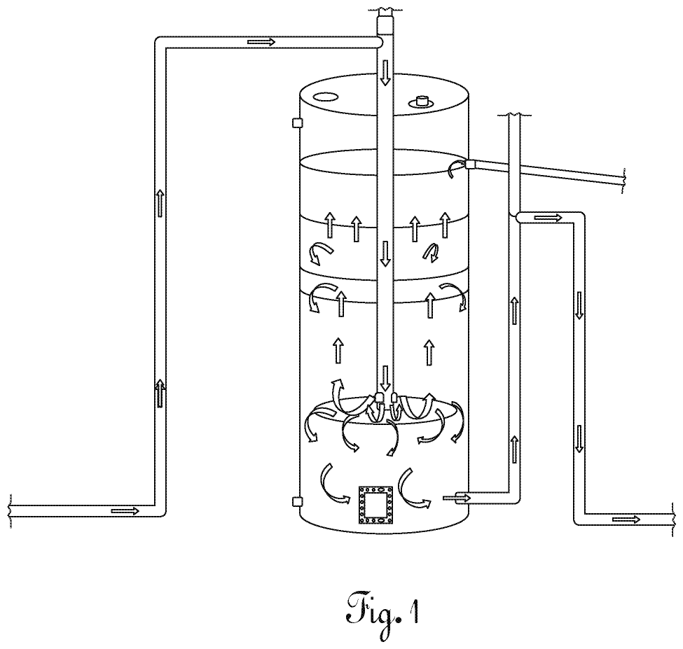

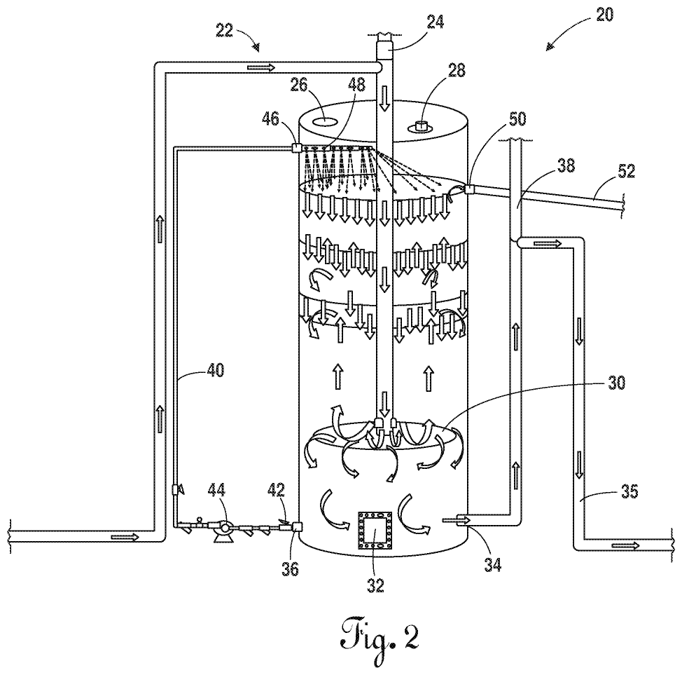

The present invention provides an assembly and process for oil-water separation using a gun barrel, separator and/or AST. FIG. 1 illustrates a typical separator or AST tank. An influent line containing water, oil and gas enters a tank through the top of the tank and continues to run the influent toward a lower region of the tank where the influent is ultimately disbursed. The influent leaves the influent line into a portion of the tank that is predominantly water. Much of the influent entering the tank contacts a diffuser plate to facilitate dispersion of the influent. The water portion of the influent has a tendency to remain lower in the tank due to the relative densities of the influent components. Conversely, the oil and gas portion of the influent has a tendency to disperse upward in the tank. Note, as the water, oil and gas enter the gun barrel through interior piping, it is distributed on the diffuser plate, to spread the water flow out and slow the rate (velocity) down so that hydrocarbons with a lighter density will separate.

As alluded to above, the tank contains several layers of material. Notably the water and oil form distinct layers, with water in the lowest level of the tank. The gun barrel interface (i.e., “pad”) is a barrier forming between the oil and water layers. It consists of oil wet hydrocarbons, organic material, biofilm, inorganic materials and Technologically Enhanced Naturally Occurring Radioactive Material (TENORM). TENORM is naturally occurring radioactive material concentrated or exposed to the accessible environment as a result of human activities such as manufacturing, mineral extraction, or water processing. At the interface, the flow of oil is trapped with flow up limited for lighter hydrocarbons.

The gun barrel in FIG. 1 also comprises gun barrel bottom side ports and tank man hatches located near the bottom of the tank. Also located near the bottom of the tank is an outlet line for water. Along the outlet line is an external gun barrel water leg. The gun barrel water leg sets the water oil interface level inside of the gun barrel by equaling the pressure between the water line and the tank. Located near the top of this tank are the gun barrel top side port, gun barrel top port, and gun barrel man hatch. The influent line comprises a gas/VRU port located on the exterior of the tank. There is also a gun barrel oil flow over port where separated oil floats over to oil storage tanks. This port is located in the upper region of the tank to promote the removal of oil.

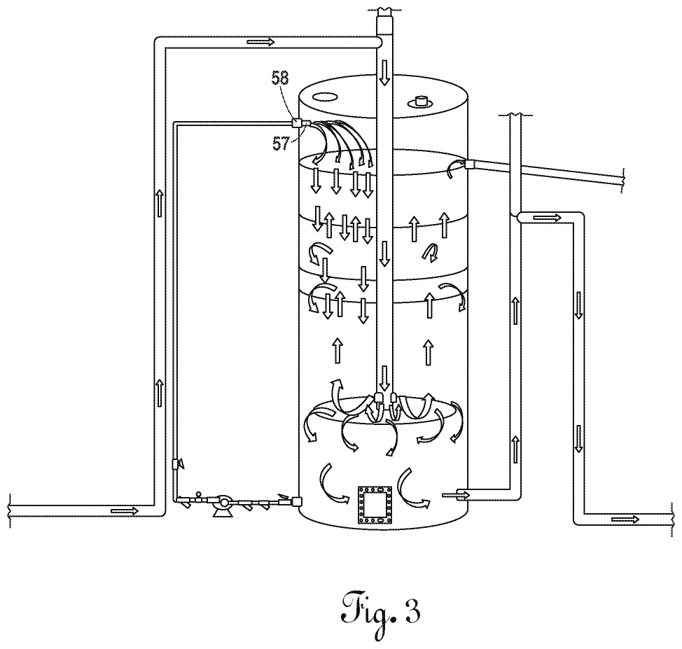

FIG. 2 shows an embodiment of the present invention wherein fluid is recirculated within the gun barrel assembly. Namely, fluid is drawn from the lower region of the tank and returned to the upper portion of the tank. In particular, the recirculated fluid reenters the tank somewhere above the upper surface of fluid in the tank. In this embodiment, the recirculated fluid enters through a horizontal nozzle. In this embodiment, influent consisting of water, oil and gas enters the gun barrel tank 20 through the influent line 22. The gun barrel tank 20 is generally cylindrical. It has a ceiling, a floor, and a wall. The influent line 22 enters the tank 20 through its ceiling and extends downwardly toward its floor. A Vapor Recovery Unit (“VRU”) port 24 exists along the influent line 22. A gun barrel top port 26 and gun barrel man hatch 28 exist on the ceiling of the gun barrel.

As fluid exits the influent line it is brought into contact (generally) with a diffuser plate 30. The diffuser plate 30 could exist at various locations inside of the tank—and in some embodiments will be adjustable—but it is ideally positioned in the lower portion of the tank 20. A second man hatch 32 is located in the lower portion of the tank 20. Also located in the lower portion of the tank 20 are bottom side ports 34, 36. The bottom side port 34 allows for the movement of fluid (principally water) out of the tank 20 through the gun barrel external water leg 38.

Fluid in the bottom portion of the tank is drawn through bottom side port 36 into the recirculation line 40. In this embodiment, an isolation valve 42 is positioned on the recirculation line in close proximity to bottom side port 36. Fluid in the recirculation line 40 passes through the isolation valve and eventually a recirculation line pump 44. The recirculation line pump 44 draws fluid from the bottom portion of the tank and directs the fluid upwardly. The upward moving fluid in the recirculation line 40 reenters the tank 20 through the gun barrel top side port 46, which is connected to a horizontal nozzle 48. Recirculated fluid sprays from the horizontal nozzle 48 over the surface oil in the gun barrel and disperses the surface, which improves separation and hydraulic efficiency.

Oil leaves the tank through an oil flow over port 50, which is located in the upper portion of the tank. The oil continues through the oil flow over line 52, which directs the oil to the oil storage tank(s).

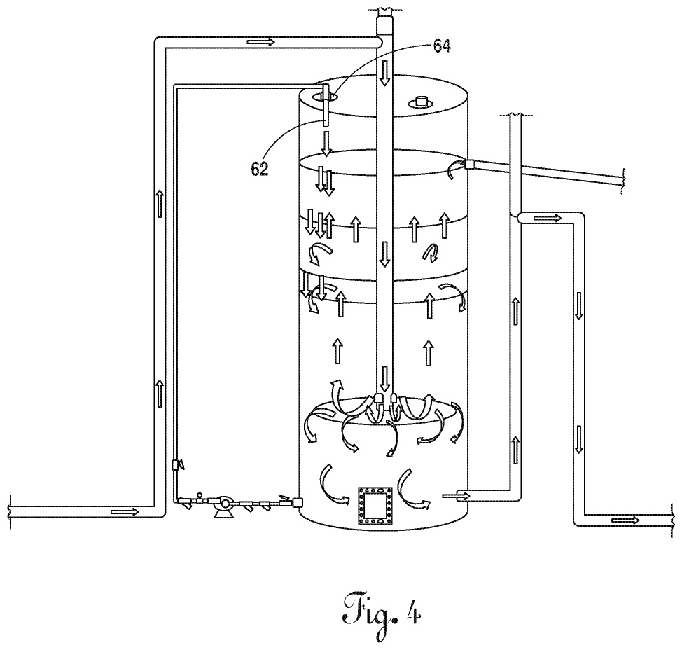

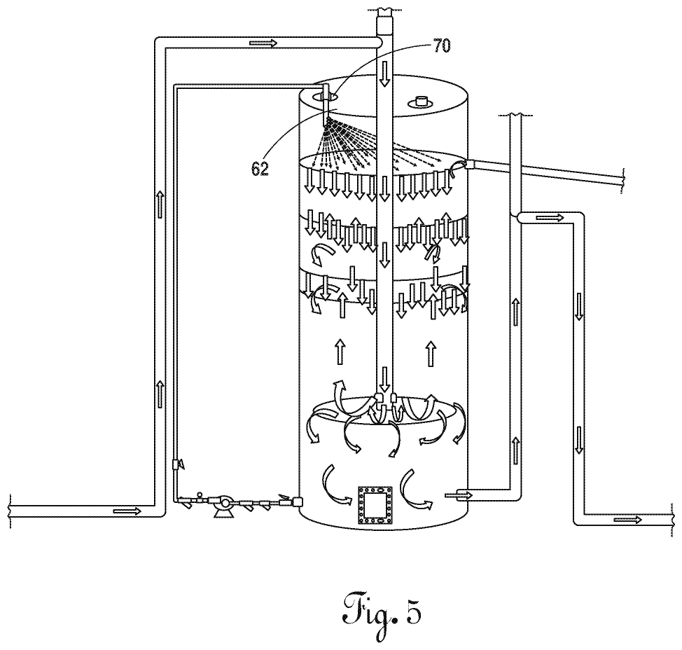

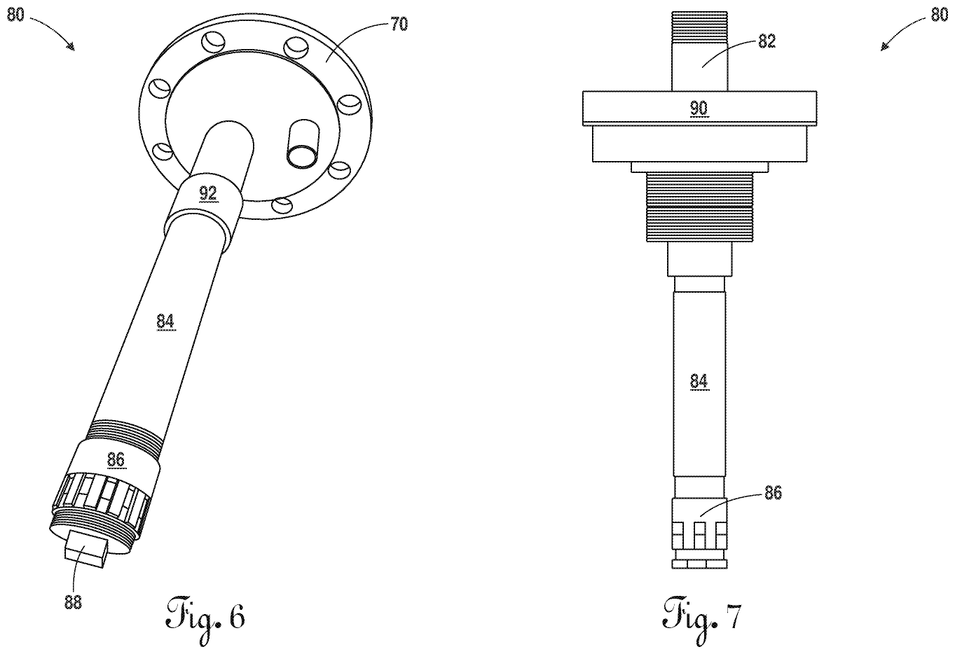

FIG. 3, FIG. 4, and FIG. 5 show alternative embodiments of the invention wherein the gun barrel recirculation line returns fluid to the upper region and/or top of the tank through an external or internal pipe and/or nozzles. FIG. 3 shows fluid recirculating and returning to the tank through open pipe 56 after it has passed through the gun barrel top side port 58. This embodiment does not incorporate a nozzle and would create a channeling effect of fluids through the pad and interface.

FIG. 4 shows fluid recirculating and returning to the tank through open pipe 62 after it has passed through the gun barrel top port 64 and would create a channeling effect of fluids through the pad and interface (i.e., a hole in the pad).

FIG. 5 shows fluid recirculating and returning to the tank through vertical nozzle 68 after it has passed through the gun barrel top port 70 and would create a diffused fluid rain effect of fluids across and then through the pad and interface.

FIG. 6 and FIG. 7 are two views of a vertical nozzle. In embodiments incorporating a vertical nozzle, recirculated fluid passes through the recirculation line into the vertical nozzle 80 through the vertical nozzle throat recirculation line connection 82. It passes through the vertical nozzle throat 84 to the vertical nozzle adjustable diffuser head 86. It is adjustable by screwing the cap in and reducing the diffuser orifice area. Doing so would increase the velocity and distance that fluids would be dispersed. Doing so would prevent the channeling of a singular port that would only open a small amount of the surface area that the pad and interface would cover. In this embodiment, there is a vertical nozzle diffuser base 88. In this embodiment, it should have or can have some small ports to allow some fluid to flow straight down and at angles. It is adjustable to increase the velocity and distance the spray pattern would distribute water across the pad and interface. This increased velocity and distance increases the area of clean oil recovery, which increases the volume of oil skimmed (recovered) and minimizes the amount of oil carried over to the water tanks. In other embodiments, the vertical nozzle diffuser base does not exist. In further alternative embodiments, the vertical nozzle diffuser base is replaced with other parts that facilitate the spray pattern. In this embodiment, the vertical nozzle attaches to the gun barrel and is held in place by way of the vertical nozzle matting flange 90. In the embodiment shown in FIG. 6, the vertical nozzle 80 comprises a vertical nozzle throat 84 with an extender 92 to place the vertical nozzle diffuser at a greater depth into the tank. Modifying the depth of the vertical nozzle impacts the horizontal trajectory of recirculated fluid, as well as the force with which the recirculated fluid contacts the surface oil located near the top of the gun barrel.

FIG. 8 is a vertical nozzle with customized spray patterns and an adjustable diffuser head (e.g., air bladder on the head), which could adjust/alternate flow rate or pattern. For example, using wave action the operator could move materials/chemistry to one area. By contrast, a static system could facilitate a direct attack.

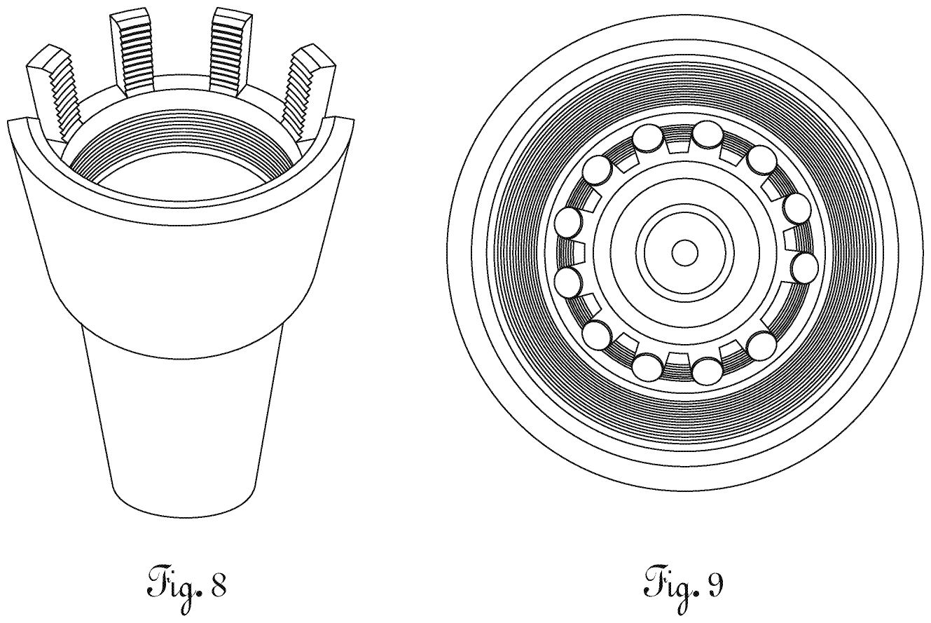

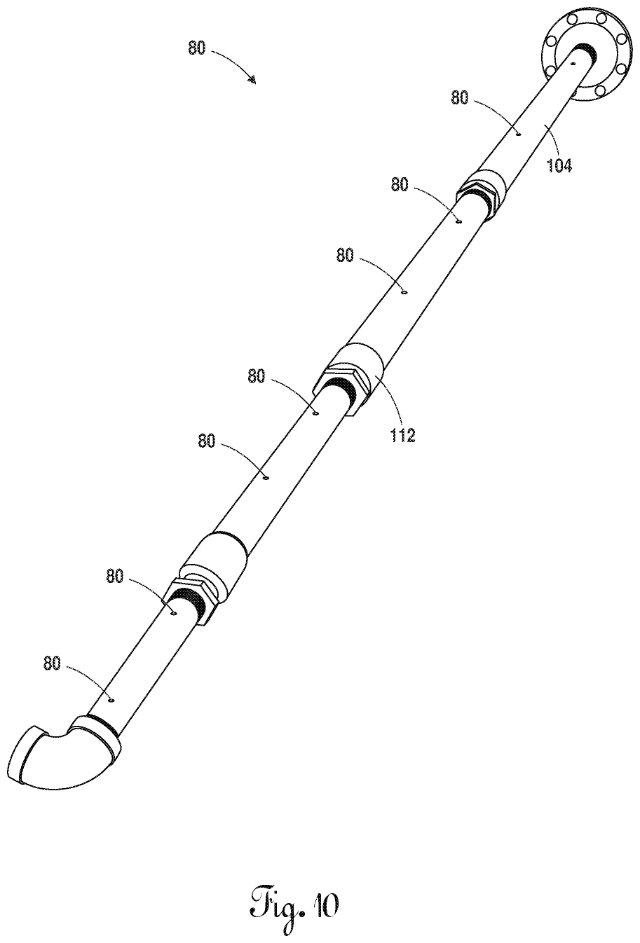

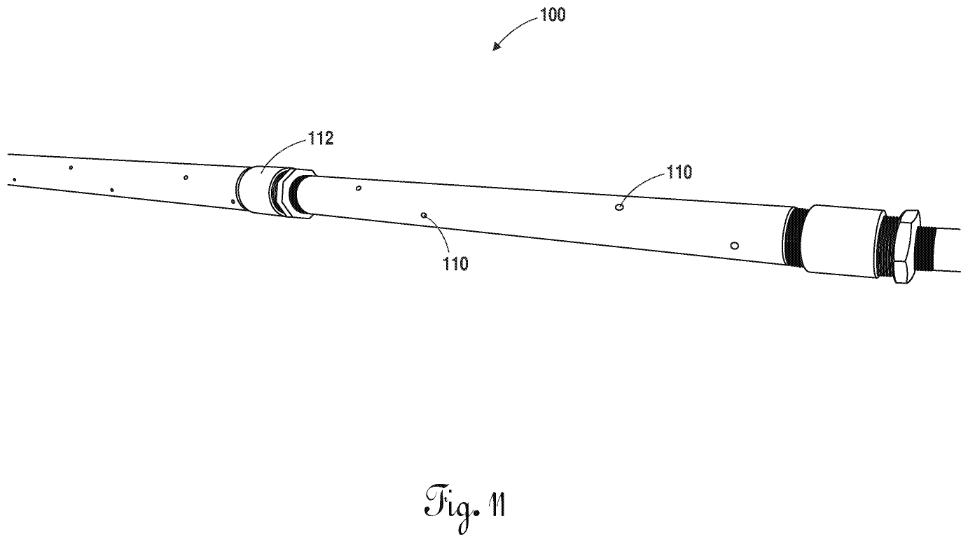

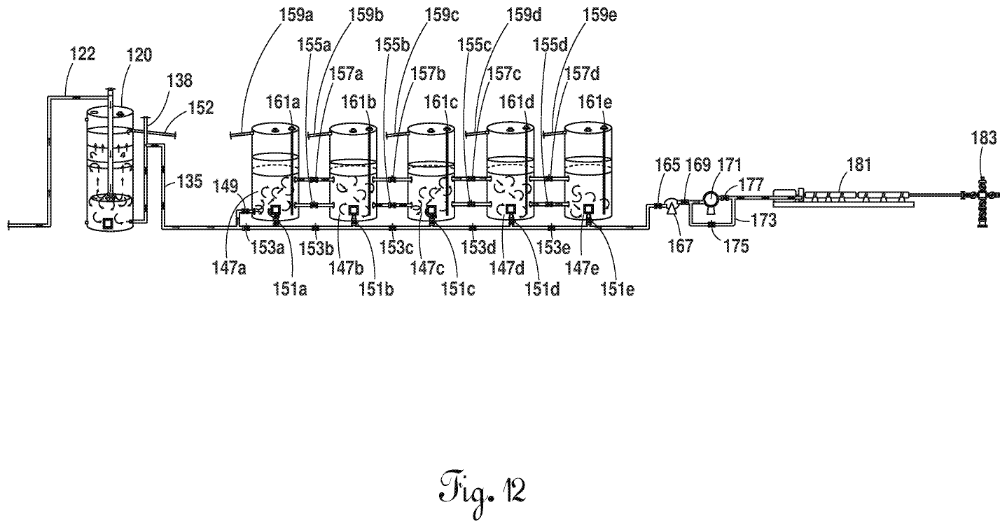

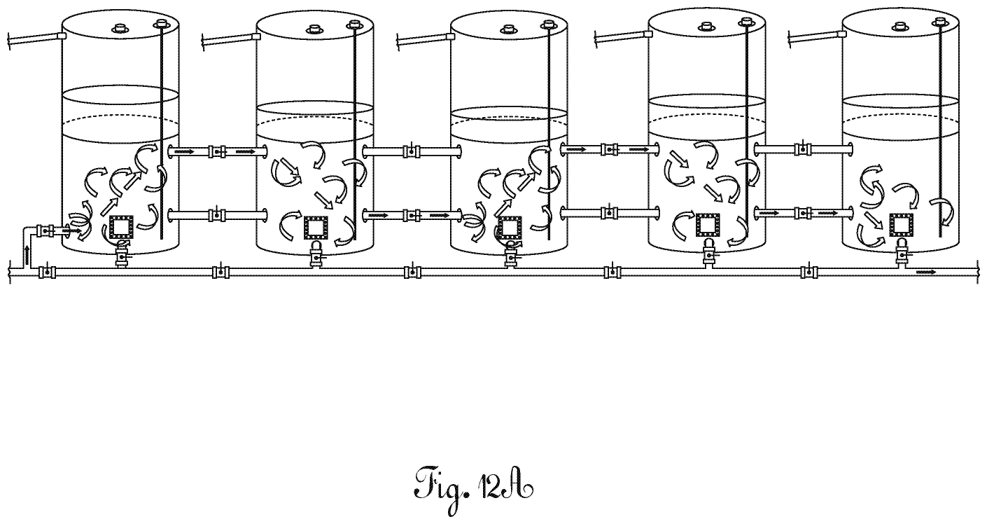

FIG. 9 is looking down at the interior of a vertical nozzle that can have an adjustable base from the flange. This would allow for adjustment to the vertical depth of the nozzle.

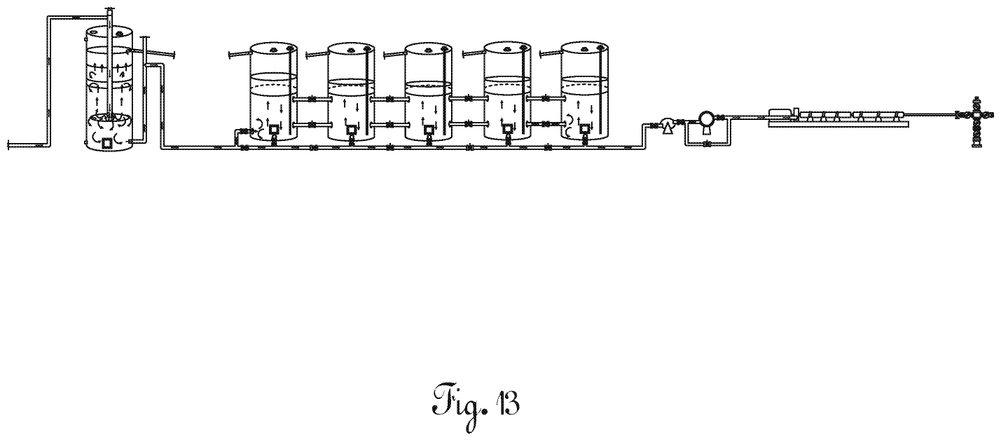

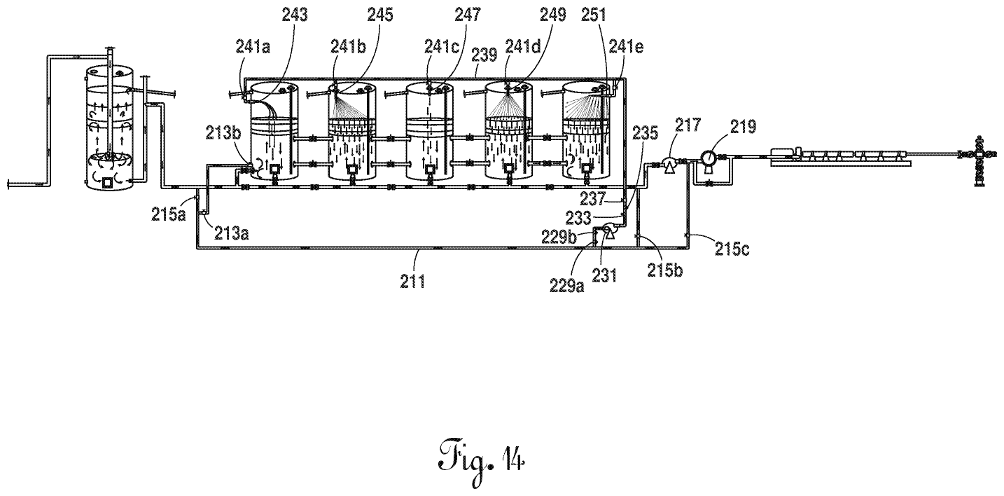

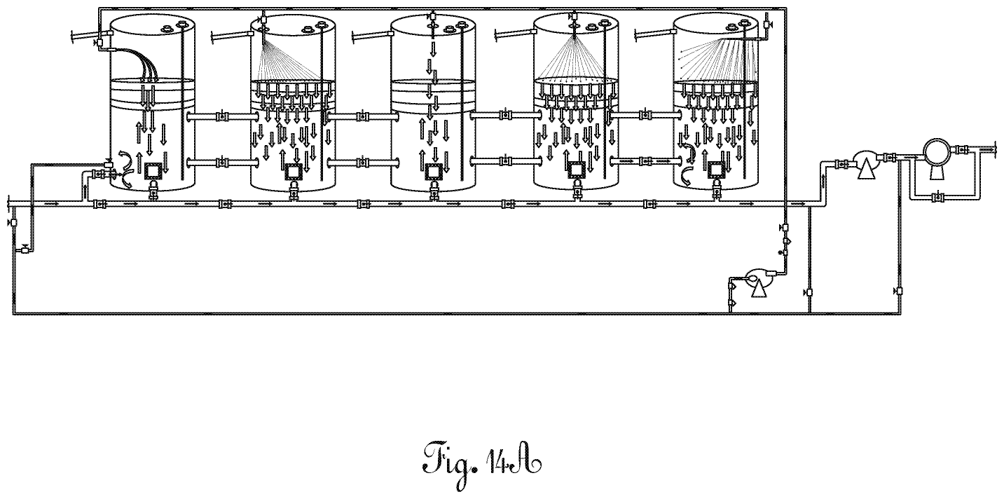

FIG. 10 and FIG. 11 are two views of a horizontal nozzle. In embodiments incorporating a horizontal nozzle, recirculated fluid passes through the recirculation line into the horizontal nozzle 100 through the horizontal nozzle throat recirculation line connection 102 (not shown). It passes through the horizontal nozzle throat 104 to the vertical nozzle end nozzle 106 and customized horizontal nozzle adjustable diffuser base 108 with a 10-degree to 360-degree spray pattern. The horizontal nozzle throat 104 is adorned with orifices at customized angles of attack 110 that creates a spray fluid across the oil surface inside of the gun barrel where pads would form and prevents and reduces oil skimming (recovery). In this embodiment, the horizontal nozzle 100 comprises a horizontal nozzle throat 104 with an extender 112 to extend the horizontal nozzle further into the tank. By doing so, the spray will reach the same amount of the oil surface inside of the tank as the vertical nozzle. The reason for the vertical and or the horizontal nozzle is to optimize the existing access ports that may be available on a tank. Some tanks may only have access ports that would require the vertical or horizontal nozzle application. If no port is available it would be up to the customer to choose which angle of attack is preferred based on the gun barrel, separator, or AST.

One of ordinary skill in the art will appreciate a variety of embodiments that capture the spirit of the present invention. For example, in alternative embodiments, the bottom side port leading fluid to the recirculation line could exist on the floor of the tank rather than along the side wall, with an internal or external pump and piping system.

In some embodiments of the present invention, tanks exist and operate with lids/covers. In other embodiments, tanks exist and operate without lids/covers. In further embodiments, tanks exist and operate with and without lids/covers.

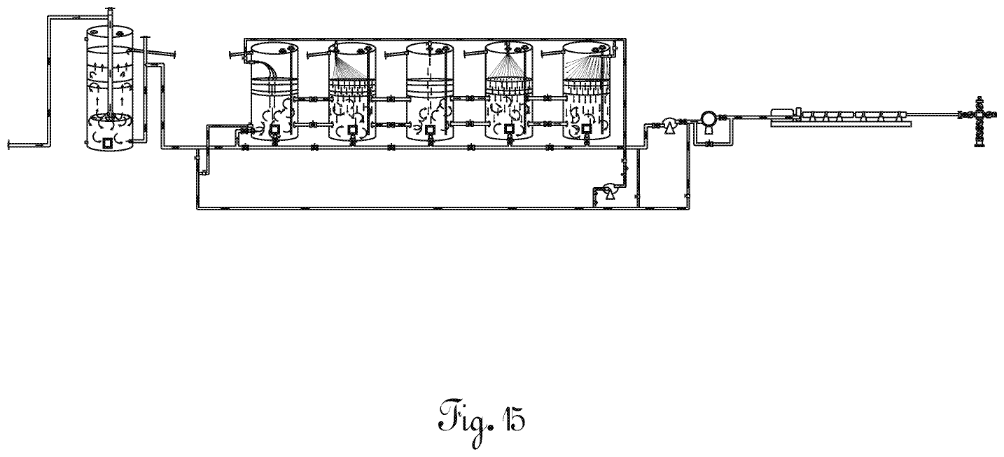

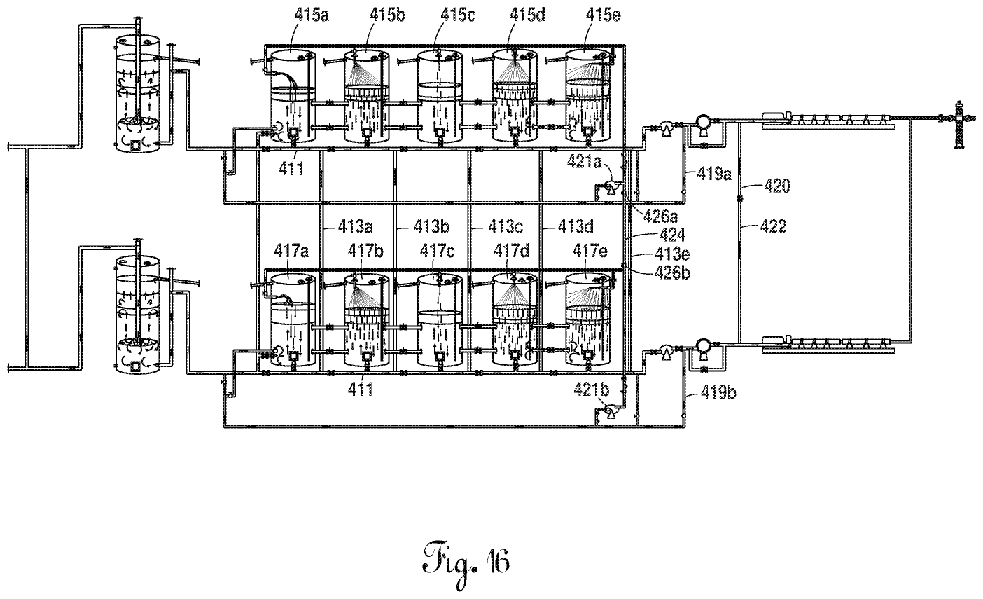

It is known in the prior art that a plurality of water tanks can exist downstream of a gun barrel. FIG. 12 and FIG. 13 illustrate two similar configurations embodying this concept. FIG. 12 illustrates a gun barrel and multiple water tank assembly configured as a single train operating as an over/under flow-through system.

FIG. 12 illustrates a gun barrel 120 that receives water, oil and gas via an influent line 122. Water exits the gun barrel 122 through a main water trunk line 135 where it is directed to a train of five water tanks 147a, 147b, 147c, 147d, 147e. A water leg 138 exists along the line 135. Water flow through the main water trunk line 135 is restricted via one or more isolation valves 153a, 153b, 153c, 153d, 153e. Oil exits the gun barrel through an oil flow over line 152.

This train of five water tanks exists downstream of the gun barrel. Water enters the train through an isolation valve 149 located near a port positioned at or near the bottom of the first water tank 147a. Generally, water may exit the first tank through a trunk line 151a, lower crossover line 155a, or an upper crossover line 157a. However, the over-under configuration restricts water flow through two of these lines. With the over under configuration, water exits the first water tank 147a through an upper crossover line 157a. Arrows shown here illustrate movement of the water upward from the inlet toward the upper crossover line. Similarly, water likely leaves the water tanks through a trunk line 151a, 151b, 151c, 151d, 151e, a lower crossover line 155a, 155b, 155c, 155d, 155e, or an upper crossover line 157a, 157b, 157c, 157d, 157e. Isolation valves exist along each of these lines 151a, 151b, 151c, 151d, 151e, 155a, 155b, 155c, 155d, 155e, 157a, 157b, 157c, 157d, 157e to permit or restrict flow. By alternating how the valves along the upper and lower crossover lines are opened/closed, the operator can facilitate an over/under flow through system. As shown in FIG. 12, upper crossover line 157a is open and the lower crossover line 155a is closed. This promotes the water to move upwardly from the inlet port through the water of the first tank 151a. The water then enters the second tank 151b. The upper crossover line 157a is closed and the lower crossover line 155a is open. This promotes the water to move downwardly from the inlet port through the water in the second tank 151b. This pattern of alternating the open/close nature of the upper and lower crossover lines continues.

Each water tank also comprises an oil float-over line 159a, 159b, 159c, 159d, 159e, and a water tank level sensor 161a, 161b, 161c, 161d, 161e.

Water in the main trunk line leaves the train and passes through a main water trunk line isolation valve 165, then a filter charge pump 167, then an inlet isolation valve 169. As water exits the inlet isolation valve 169 it may pass through a downhole filter 171 or pass through a bypass line 173, which is dictated by opening/closing the bypass valve 175. Water exiting the downhole filter 171 passes through an outlet isolation valve 177 before entering a downhole injection pump 181, and finally, a disposal injection well head 183.

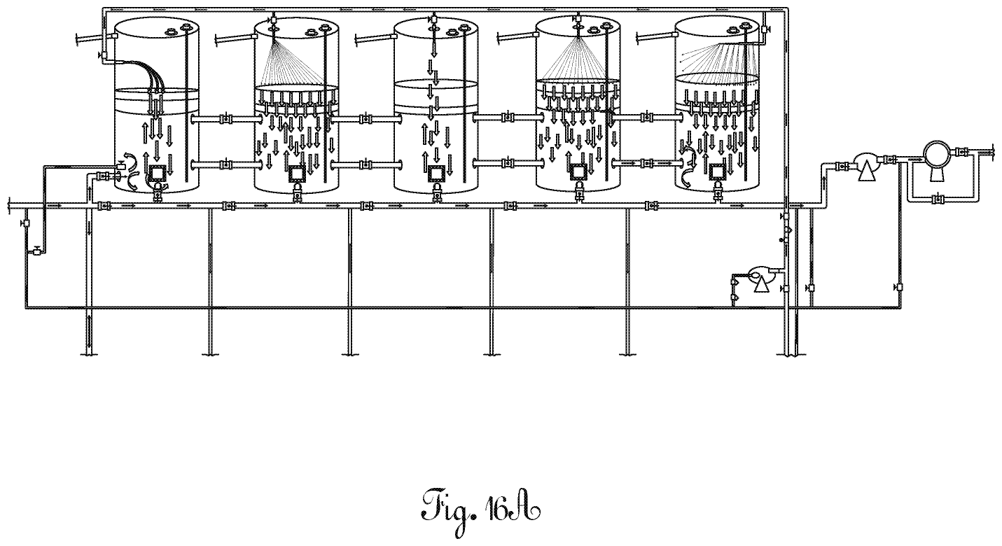

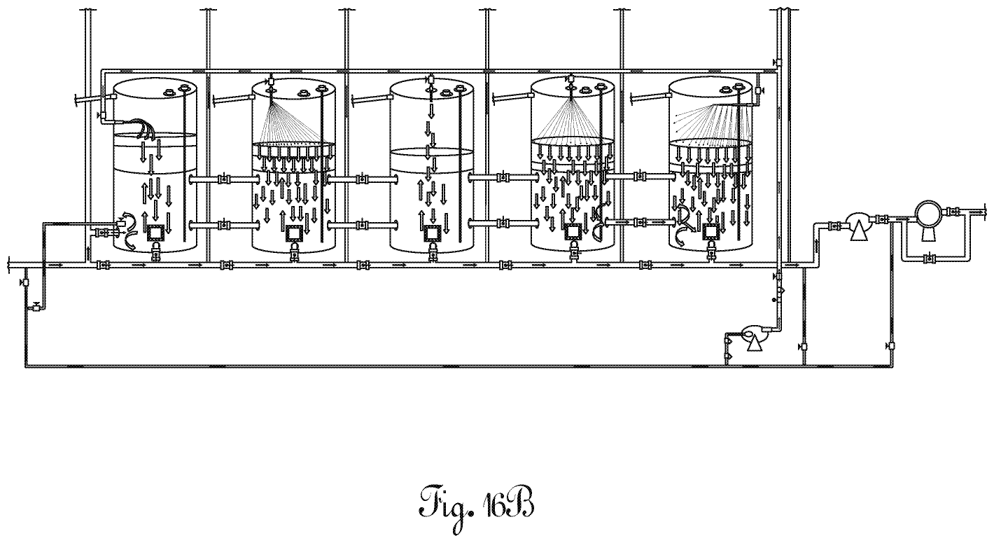

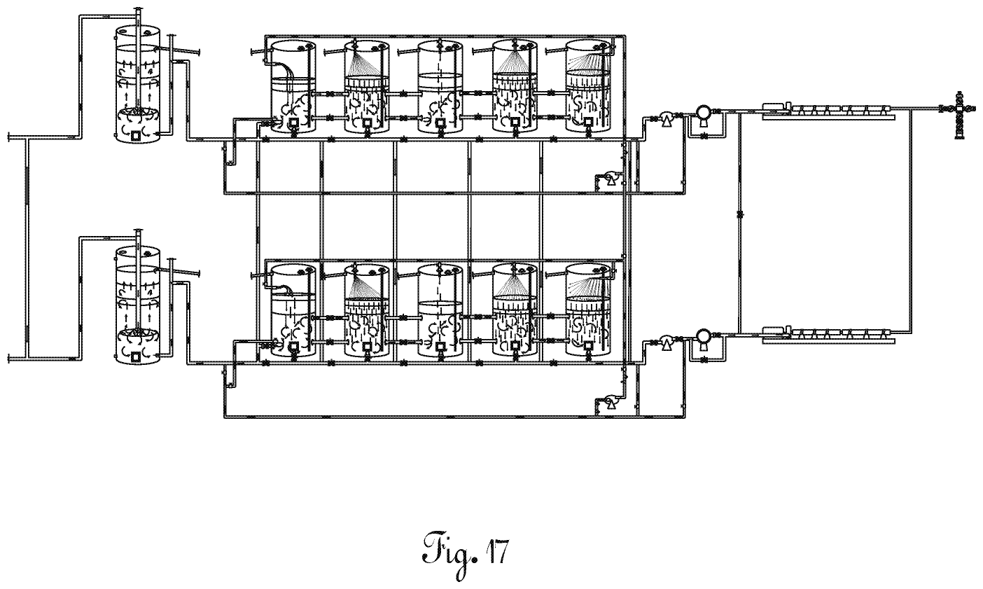

FIG. 13 illustrates a gun barrel and multiple water tank assembly configured as a single train operating as a bladder tank flow system. The equipment in this assembly is the same as the equipment in the assembly illustrated in FIG. 12. The water tank level sensors are especially helpful in this system. The valves along each of the upper and lower crossover lines are closed. Instead, water moves through the several trunk lines. Water in each tank undulates up and down like a piston. It should be noted that the lower isolation valve located between the fourth and fifth water tanks (away from the gun barrel) is open in this embodiment. Each of the upper isolation valves between the water tanks and the first three lower isolation valves between the water tanks are closed in this embodiment. The lower isolation valve is open in this embodiment is open to equalize the tanks, as these tanks will be pulled on the hardest to supply water for the downhole injection pumping process. The same remains true for similarly situated tanks (and isolation valves) in embodiments of the invention discussed below (e.g., isolation valves shown in FIGS. 14, 14A, 16, 16A, 16B).

The systems illustrated in FIG. 12 and FIG. 13 are known in the prior art.

The present invention can be incorporated into the systems illustrated in FIG. 12 and FIG. 13. FIG. 14 and FIG. 15 illustrate two such embodiments.

FIG. 14 illustrates one embodiment of the present invention wherein a gun barrel and multiple water tank assembly are configured as a single train. The assembly shown in FIG. 14 includes the same equipment as shown in FIG. 12 and FIG. 13. Like the system illustrated in FIG. 13, isolation valves positioned along the lower and upper crossover lines are closed and the water tank trunk lines are open to promote bladder flow through the water tanks. FIG. 14 also includes a recirculation assembly. To that end, water exits the first water tank and enters a recirculation line 211. Flow of that water is permitted/limited through a pair of isolation and flow control valves 213a, 213b. Water may also enter the recirculation line 211 if redirected from the main water trunk line by way of isolation and flow control valves 215a, 215b, 215c. Isolation and flow control valve 215a is positioned downstream of the gun barrel and upstream of the first water tank in the train. Isolation and flow control valve 215b is positioned downstream of the final water tank in the train and upstream of the filter charge pump 217. Isolation and flow control valve 215c is positioned downstream of the filter charge pump 217 and upstream of the downhole filter 219.

Two chemical injection ports 229a, 229b, exist along the recirculation line upstream of recirculation pump 231, which may be VFD (Variable Frequency Drive) but it is not necessary. A PSI gauge and transducer 233, chemical injection port 235, and isolation and flow control valve 237 are located downstream of the recirculation pump 231, in this embodiment. The water subsequently passes through one or more isolation and flow control valves 241a, 241b, 241c, 241d, 241e, upstream of a specific tank in the train. As illustrated here, various pipe and/or nozzle configurations can exist downstream of the isolation and flow control valves upstream of a specific tank. For example, water passing through valve 241a enters the tank through horizontal pipe 243. Water passing through valve 241b enters the tank through a vertical pipe with nozzle 245. Water passing through valve 241c enters the tank through a vertical pipe 247 without nozzle. Water passing through valve 241d enters the tank through vertical pipe with nozzle 249. Water passing through valve 241e enters the tank through horizontal pipe with nozzle 251. Here, each tank includes a level sensor, which promotes bladder tank flow.

FIG. 15 illustrates one embodiment of the present invention wherein a gun barrel and multiple water tank assembly are configured as a single train that has an over/under flow-through system as one embodiment of the present invention.

FIG. 15 consists of the same equipment as FIG. 14 and the equipment is arranged in the same manner. The system illustrated in FIG. 15 is dissimilar from FIG. 14, however, in that the system facilitates an over/under flow through system. That is, like the system illustrated in FIG. 12, isolation valves positioned along the lower and upper crossover bridges between the water tanks are opened and closed in such a way to promote over/under flow through the water tanks.

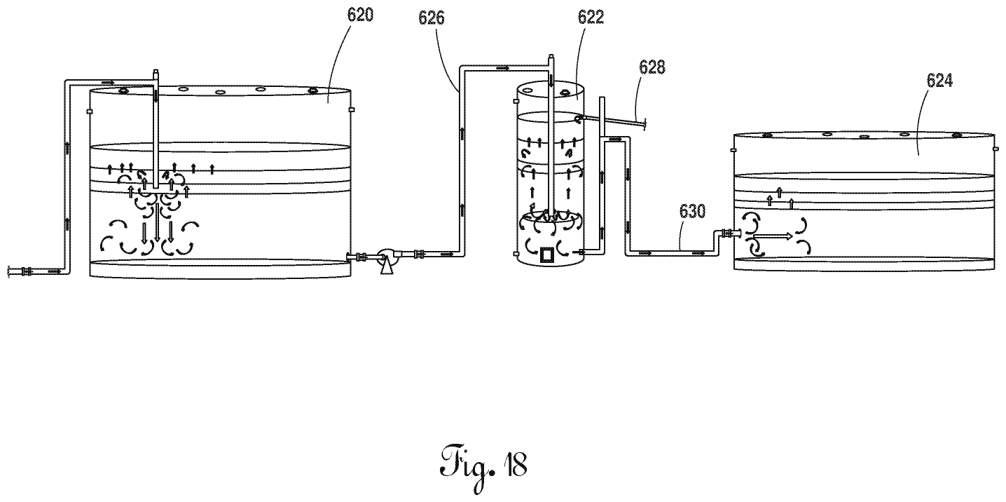

In alternative embodiments, there could be multiple recirculation lines, which draw fluid from one or more bottom side ports, and return recirculated fluid through one or more top side ports and/or top ports, as well as through internal or external means. FIG. 16 and FIG. 17 illustrate two such embodiments.

FIG. 16 illustrates a multiple gun barrel and multiple water tank assembly configured as two parallel multi-tank trains that have a bladder tank flow system as one embodiment of the present invention. Like the system illustrated in FIG. 14, there is at least one gun barrel located upstream of a train of water tanks and the water tanks facilitate bladder tank flow. The system illustrated in FIG. 16 is dissimilar from FIG. 14, however, in that FIG. 16 illustrates two trains whereas FIG. 14 illustrates a single gun barrel and a single train of tanks.

Water exits each of the gun barrels and enters a main water trunk line 411. Water moves through the main water trunk line 411 and enters the first train of water tanks through an isolation valve positioned near the lower portion of first tank 415a in the first train. Similarly, water enters the second train of water tanks through an isolation valve positioned near the lower portion of a first tank 417a in the first train. As discussed below, there is more than one way that water can enter each train. Water may enter tanks through recirculation (discussed below). Water can move through main water trunk line 411 along what are effectively two lines moving in parallel with one another along their respective train of tanks. Additionally, water can move through multiple water equalization lines 413a, 413b, 413c, 413d, 413e. Here, each equalization line is positioned downstream of at least one water tank from each train.

In this embodiment, the first train of water tanks consists of five water tanks 415a, 415b, 415c, 415d, 415e, and the second train of water tanks consists of five water tanks 417a, 417b, 417c, 417d, 417e. Water exiting each train of tanks may enter the main water trunk line 411, pass through a filter charge pump, a downhole filter, and then a downhole injection pump. Water leaving the downhole injection pumps proceeds to a disposal injection well head. Bypass lines and bypass valves are positioned in sequence with each of the down hole filters. Plumbing and at least one isolation valve exists downstream of the down hole filters to allow for combining or separation of the water exiting those filters. Upstream of each downstream filter—but downstream of the corresponding filter charge pump is a water recirculation line 419a, 419b, and an isolation and flow control valve positioned along that water recirculation line. Upstream of each filter charge pump is water recirculation line having a corresponding isolation and flow control valve positioned along that water recirculation line.

Water may enter the water recirculation lines not only downstream of water tanks 415e, 417e (which are positioned at the end of each of their trains). Water may also enter the recirculation line 419a, 419b from water tanks 415a, 417a (which are positioned at the front of each of their trains). One or more isolation and flow control valves are located along the recirculation lines downstream of water tanks 415a, 417a. Water may also enter the recirculation line 419a, 419b if redirected from downstream of the final water tank in the train and upstream of the filter charge pump; downstream of the filter charge pump and upstream of the downhole filter; and downstream of the downhole filter. Isolation and flow control valves positioned along the recirculation line at these locations facilitate the flow of water to be recirculated.

Water in the recirculation line may eventually direct to one or both trains of water tanks. Before doing so, it passes through at least one recirculation pump (e.g., VFD) 421a, 421b. FIG. 16 illustrates two chemical injection ports located upstream of each recirculation pump 421a, 421b. Embodiments with multiple chemical injection ports permit the operator to input different chemicals, and to choose the relative impact of time/flow on the chemical treatment. It is contemplated that chemical treatment will occur before entry into a tank but as close to the tank as possible for improved efficiency. Water exiting the recirculation pumps 421a, 421b enters line 424. Isolation and flow control valves 426a, 426b are positioned along line 424 between the recirculation pumps 421a, 421b. It is considered ideal to treat each train as its own system but it is not necessary. To that end, isolation and flow control valves 426a, 426b allow bridging between the first and second trains of water tanks. Along line 424 between each of the recirculation pumps 421a, 421b and their respective trains are a PSI gauge and transducer, a chemical injection port, and an isolation and flow control valve.

As water moves downstream from isolation and flow control valves 426a, 426b it moves toward the first train and the second train, respectively. Water passing through isolation and flow control valve 426a subsequently passes through or more isolation and flow control valves upstream of a specific tank, 415a, 415b, 415c, 415d, 415e. Similarly, water passing through isolation and flow control valve 426b subsequently passes through one or more isolation and flow control valves upstream of a specific tank, 417a, 417b, 417c, 417d, 417e. As illustrated here, various pipe and/or nozzle configurations can exist downstream of the isolation and flow control valves upstream of a specific tank. Here, each tank includes a level sensor, which promotes bladder tank flow.

FIG. 17 is a multiple gun barrel and multiple water tank assembly configured as two parallel multi-tank trains that have an over/under flow-through system as one embodiment of the present invention. FIG. 17 consists of the same equipment and the equipment is arranged in the same manner as FIG. 16. The system illustrated in FIG. 17 is dissimilar from FIG. 16, however, in that the two trains facilitate an over/under flow through system. That is, like the system illustrated in FIG. 15, isolation valves in FIG. 17 are positioned along the lower and upper crossover bridges between the water tanks that are opened and closed in such a way as to promote over/under flow through the water tanks.

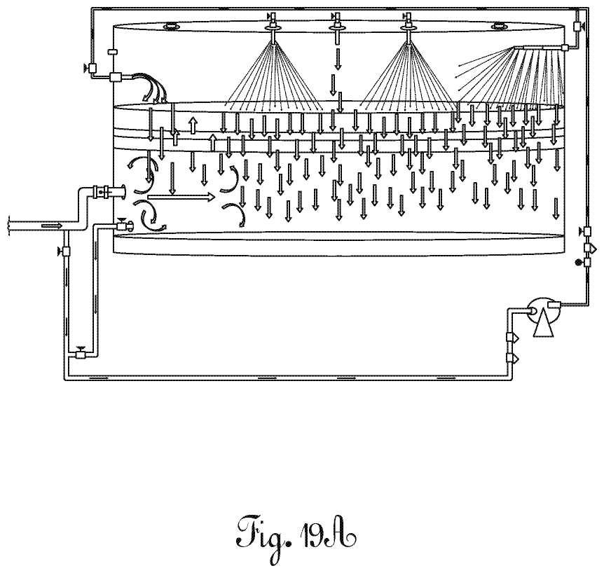

In alternative embodiments, recirculated fluid could return to the top of the tank through a combination of horizontal and vertical nozzles. In further alternative embodiments, the recirculated fluid could return through a plurality of vertical nozzles and/or a plurality of horizontal nozzles. FIG. 19 (discussed below) illustrates one such embodiment.

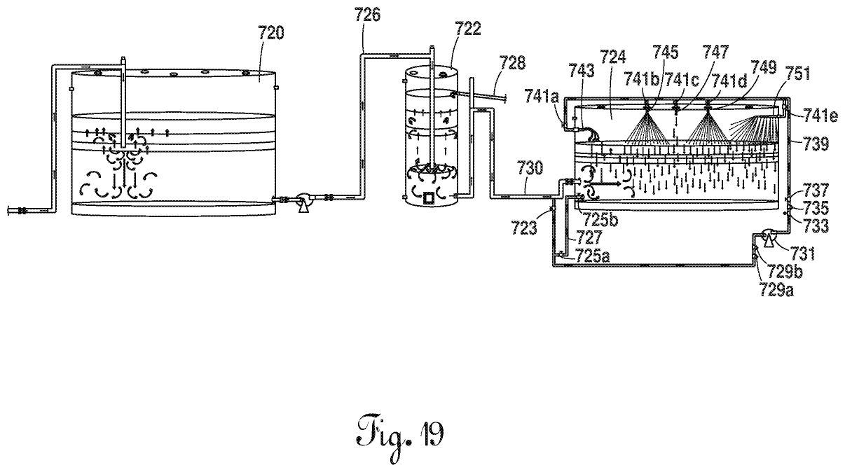

FIG. 18 illustrates two above-ground storage tanks with one gun barrel configured as a flow-through system that has been disclosed in the prior art. Specifically, FIG. 18 illustrates a first above ground storage tank 620 that is located upstream of a gun barrel 622. A second above ground storage tank 624 is located downstream of the gun barrel 622. Water, oil, and gas, exits the first above ground storage tank 620. The water passes through a transfer pump and moves through an influent line where it is delivered to the gun barrel 622. As known in the art, water exits the gun barrel near the bottom of the tank through a main water trunk line 630 and oil exits through an oil flow over line 628 located near the top of the gun barrel. Typically, the water entering the second above ground storage tank 624 enters near the lower portion of the tank 624. In further alternative embodiments, that could be changed.

FIG. 19 illustrates two above-ground storage tanks with one gun barrel configured as a flow-through recirculation system as one embodiment of the present invention. Like the system illustrated in FIG. 18, the system in FIG. 19 has two above-ground storage tanks with one gun barrel configured as a flow-through system. It also comprises a recirculation line and related equipment. A first above ground storage tank 720 that is located upstream of a gun barrel 722. A second above ground storage tank 724 is located downstream of the gun barrel 722. Water, oil, and gas, exit the first above ground storage tank 720. The water passes through a transfer pump and moves through an influent line where it is delivered to the gun barrel 722. As known in the art, water exits the gun barrel near the bottom of the tank through a main water trunk line 730 and oil exits through an oil flow over line 728 located near the top of the gun barrel. Typically, the water entering the second above ground storage tank 724 enters near the lower portion of the tank 724.

This embodiment of the present invention further comprises isolation and flow control valves 723, 725a, 725b, located along a water recirculation suction line 727. Water travelling through the main trunk line 730 can be directed through isolation and flow control valves 723 to enter the water recirculation suction line 727. Similarly water can exit the second above ground storage tank 724 into water recirculation suction line 727. This water can be controlled using isolation and flow control valves 725a, 725b.

Chemical injection ports 729a, 729b are positioned along water recirculation suction line 727. The operator can add one or more chemicals (e.g., treatments) to the water at the injection points (e.g., injection ports). The water moving through the water recirculation suction line 727 passes through the recirculation pump (e.g., VFD) 731. Located downstream of the pump, in this embodiment, are a PSI gauge and transducer 733, chemical injection port 735, and isolation and flow control valve 737. Chemical injection port 735 serves as an additional chemical injection point. In this instance, it is located downstream of the pump, which may be advantageous in some instances. Isolation and flow control valve 737 can prohibit and/or encourage the flow of water through this line.

Water continuing through the recirculation suction line proceeds toward a series of isolation control valves 741a, 741b, 741c, 741d, 741e. Isolation control valves 741a, 741b, 741c, 741d, 741e permit/restrict the flow of water (sometimes, but not necessarily, chemically treated) into the top (or upper portion) of the tank. In this embodiment, different nozzles, etc., extend downstream of the respective isolation control valves 741a, 741b, 741c, 741d, 741e. FIG. 19 shows no nozzle—just an open horizontal pipe 743—allowing for the passage of water into the tank. Water passing through isolation control valves 741b, 741d disperses into the tank through vertical pipes with nozzles 745, 749. Water passing through isolation control valve 741c disperses into the tank through a vertical pipe without a nozzle 747. Water passing through isolation control valve 741e disperses into the tank through a horizontal pipe with nozzle 751. The second above ground storage tank is large, having a diameter on the magnitude of 40 feet. It is anticipated that the operator can better treat the tank with multiple pipes/nozzles than a single pipe or nozzle. The operator can also better control the disbursement of water/chemicals in real time. Pad imbalances may form and the ability to control the disbursement of water/chemicals would aid in remedying that issue.

In alternative embodiments of the present invention as shown in FIG. 19, the invention may exist without a gun barrel. That is, the present invention may operate on water storage tanks independent of gun barrel assemblies.

The present invention may apply to weir pits, wherein fluid is taken from the pit and misted across the pit and/or adjacent tank or gun barrel.

This application has presented several embodiments of the present invention and discussed various devices, such as valves, pumps, tanks, lines, etc. It is contemplated that these units and devices may exist in varying arrangements, combinations, and still reflect the spirit of the present invention. For example, the embodiments shown in FIGS. 14, 14A, 15 incorporate trains of five water tanks; and the embodiments shown in FIGS. 16, 16A, 16B, 17 incorporate two trains of five water tanks each. The prevent invention may be incorporated into other assemblies, which may have fewer (or more) water tanks.

In alternative embodiments, the nozzles could be adjustable in length and/or flow, which could be controlled manually or through the use of automation (e.g., pistons, air bladders and/or hydraulic pumps).

In alternative embodiments, fluids (e.g., water) from an alternate or adjacent tank, whether in parallel or in series, whether upstream and downstream, may serve as a source of fluid (e.g., water) other than the water that is internal and integral to that specific gun barrel, Separator or AST.

The present invention is described above in terms of a preferred illustrative embodiment in which a specifically described refining plant and method are described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

1. A process for operating a tank recirculation system comprising the steps of:
removing fluid from the floor or lower half of the tank;
pumping the removed fluid; and
spraying the removed fluid across the top layer of fluid in the tank.

2. The process of claim 1 wherein the step of spraying the removed fluid involves passing the removed fluid through at least one vertical nozzle.

3. The process of claim 1 wherein the step of spraying the removed fluid involves passing the removed fluid through at least one horizontal nozzle.

4. A tank recirculation system comprising:
a tank;
an outlet connected to the floor or lower half of the tank;
an inlet connected to the ceiling or upper half of the tank;
a recirculation line connected to the outlet and the inlet;

5. The tank recirculation system of claim 4 further comprising at least one nozzle connected to the recirculation line.

6. The recirculation system of claim 4 comprising at least one chemical injection point.
